(19) United States
(12) Patent Application Publication
(10) Pub. No.: US 2020/0227741 A1
(43) Pub. Date: Jul. 16, 2020

(54) CATHODE MATERIAL AND ELECTROCHEMICAL DEVICE INCLUDING CATHODE MATERIAL

(71) Applicant: NINGDE AMPEREX TECHNOLOGY LIMITED, Ningde City (CN)

(72) Inventors: Liang WANG, Ningde City (CN); Meng WANG, Ningde City (CN); Leimin XU, Ningde City (CN); Pengwei CHEN, Ningde City (CN)

(73) Assignee: NINGDE AMPEREX TECHNOLOGY LIMITED

(21) Appl. No.: 16/294,398

(22) Filed: Mar. 6, 2019

(30) Foreign Application Priority Data
Jan. 10, 2019 (CN) 201910022626.5

(51) Int. Cl. H01M 4/525; H01M 10/0525; H01M 4/04; C01G 51/00

(52) U.S. Cl. CPC H01M 4/525; H01M 10/0525; H01M 4/0471; C01G 51/42; H01M 2004/028; C01P 2004/03; C01P 2004/04; C01P 2004/61; C01P 2002/72

(57) ABSTRACT

The present application relates to a cathode material and an electrochemical device including the cathode material. The cathode material includes a substrate and a coating layer, wherein the substrate is a cathode active substance containing a cobalt element and capable of intercalating and deintercalating lithium ions, and the coating layer is located on the surface of the substrate, wherein the coating layer is LaₓLi_{y}Co_{z}Oₐ, wherein 1≤x≤2, 0<y≤1, 0<z≤1, 3≤a≤4 and 3x+y+3z=2a. The coating layer can not only reduce the side reaction between the electrolyte and the cathode active substance in the electrochemical device, but also act as a fast lithium ion conductor layer to accelerate the intercalation and deintercalation of lithium ions, and also has electrochemical activity. Therefore, the cathode material having the above coating layer not only has good cycle stability, but also has superior rate performance and impedance characteristics, and has high energy density.

### CROSS REFERENCE TO RELATED APPLICATIONS

The present application claims the benefit of priority from the China Patent Application No. 201910022626.5, filed on 10 Jan. 2019, the disclosure of which is hereby incorporated by reference in its entirety.

### BACKGROUND

### 1. Technical Field

The present application relates to the technical field of energy storage, and in particular to a cathode material and an electrochemical device including cathode material.

### 2. Description of the Related Art

With the popularity of consumer electronics products such as notebook computers, mobile phones, handheld game consoles, tablet computers, mobile power supplies and drones, the requirements for electrochemical devices (e.g., batteries) are becoming more stringent. For example, people not only require batteries to be lightweight, but also require batteries with high capacity and a long working life. Among many types of batteries, lithium-ion batteries have occupied a dominant position in the market due to their outstanding advantages, such as high energy density, good safety, low self-discharge, no memory effect, and long working life. The cathode material is one of the most critical components in a lithium-ion battery. At present, the development of cathode materials with high energy density, ultra-high rates, and a long working life is the focus of research and development in the field of lithium-ion batteries.

### SUMMARY

The present application provides a cathode material and a method of preparing the cathode material, in an attempt to solve at least one of the problems in the related art at least to some extent.

In one embodiment, the present application provides a cathode material, and the cathode material includes a substrate, wherein the substrate is a cathode active substance containing a cobalt element and capable of intercalating and deintercalating lithium ions; the cathode material further includes a coating layer, located on the surface of the substrate; wherein the coating layer is LaₓLi_{y}Co_{z}Oₐ, wherein 1≤x≤2, 0<y≤1, 0<z≤1, 3≤a≤4 and 3x+y+3z=2a.

In some embodiments, in the cathode material, the mass fraction of LaₓLi_{y}Co_{z}Oₐ is from about 0.01% to about 5% or from about 0.2% to about 2%.

In some embodiments, LaₓLi_{y}Co_{z}Oₐ is 1.5≤x≤2, 0<y≤0.5, 0<z≤0.5 and 3.5≤a≤4.

In some embodiments, the coating layer is La₂Li_{0.5}Co_{0.5}O₄.

In some embodiments, the general formula of the cathode active substance is expressed as Li_{c}Co_{d}Mi_{1-d}O₂, wherein the element M includes at least one of Co, Ni, Mn, Al, Mg, Ti, Zr, F, Y, Nb, La, B, Mo, V or Ce, wherein 0.95≤c≤1.05 and 0.95≤d≤0.9999.

In some embodiments, the median particle diameter Dv50 of the cathode material is from about 4 μm to about 22 μm or from about 8 μm to about 18 μm.

In some embodiments, the specific surface area of the cathode material is from about 0.08 m²/g to about 0.4 m²/g or from about 0.1 m²/g to about 0.3 m²/g.

In one embodiment, the present application further provides an electrochemical device, including a cathode, an anode, a separator and an electrolyte, wherein the cathode includes the cathode material according to the above embodiments of the present application.

In some embodiments, the electrochemical device is a lithium-ion battery.

In some embodiments, the present application further provides a method for preparing the above cathode material, including: dispersing a lanthanum salt, a lithium salt and a cobalt salt in an organic solution, adding a complexing agent, stirring uniformly and removing the organic solution to obtain a LaₓLi_{y}Co_{z}Oₐ sol; mixing the LaₓLi_{y}Co_{z}Oₐ sol with a cathode active substance containing a cobalt element and capable of intercalating and deintercalating lithium ions, and drying to obtain a gel precursor; and mixing and sintering the gel precursor to obtain the cathode material.

In some embodiments, in the cathode material, the mass fraction of the LaₓLi_{y}Co_{z}Oₐ is from about 0.01% to about 5% or from about 0.2% to about 2%.

In some embodiments, LaₓLi_{y}Co_{z}Oₐ is 1.5≤x≤2, 0<y≤0.5, 0<z≤0.5 and 3.5≤a≤4.

In some embodiments, the general formula of the cathode active substance is expressed as Li_{c}Co_{d}Mi_{1-d}O₂, wherein M includes at least one of Co, Ni, Mn, Al, Mg, Ti, Zr, F, Y, Nb, La, B, Mo, V or Ce, wherein 0.95≤c≤1.05 and 0.95≤d≤0.9999.

In some embodiments, the ratio of the molar amount of the complexing agent to the sum of the molar amounts of the lanthanum salt, the lithium salt and the cobalt salt is about (1.0-1.5):1 or about (1.1-1.3):1.

In some embodiments, the lanthanum salt includes at least one of La(NO₃)₃ or LaCl₃, the lithium salt includes at least one of LiOH or Li₂CO₃, and the cobalt salt includes at least one of CoCl₂, CoSO₄, Co(NO₃)₂, Co(CH₃COO)₂ or CoC₂O₄.

In some embodiments, the complexing agent includes at least one of citric acid, β-hydroxybutyric acid, tartaric acid, phthalic acid, α-naphthalene acetic acid or diethylenetriaminepentaacetic acid.

In some embodiments, the drying temperature is from about 80° C. to about 200° C. or from about 120° C. to about 150° C.

In some embodiments, the drying time is from about 8 h to about 24 h or from about 12 h to about 18 h.

In some embodiments, the sintering temperature is from about 400° C. to about 900° C. or from about 600° C. to about 800° C.

In some embodiments, the sintering time is from about 3 h to about 12 h or from about 5 h to about 7 h.

In some embodiments, the increase rate of the sintering temperature is from about 2° C. to about 10° C., from about 3° C. to about 8° C. or from about 4° C. to about 6° C. per minute.

In some embodiments, the sintering atmosphere is oxygen or air.

The lithium-ion battery prepared by the cathode material of the present application can operate in a voltage range of about 4.0 V to 4.8 V, for example, at a voltage of 4.0 V, 4.1 V, 4.2 V, 4.3 V, 4.4 V, 4.5 V, 4.6 V, 4.7 V, 4.8 V or the like.

### BRIEF DESCRIPTION OF THE DRAWINGS

The drawings that are necessary to describe the embodiments of the present application or the prior art will be briefly described below to facilitate the description of the embodiments of the present application. Obviously, the drawings in the following description are only partial embodiments of the present application. For those skilled in the art, the drawings of other embodiments can still be obtained according to the structures illustrated in the drawings without the need for creative labor.

FIG. 1 is an X-ray diffraction (XRD) pattern of coated lithium cobalt oxide in Example 1, uncoated lithium cobalt oxide in Comparative Example 1, and La₂Li_{0.5}Co_{0.5}O₄ according to the present application.

FIG. 2 is a scanning electron microscope (SEM) image of the uncoated lithium cobalt oxide in Comparative Example 1.

FIG. 3 is an SEM image of the coated lithium cobalt oxide in Example 1.

FIG. 4a is a cross-sectional SEM image of the coated lithium cobalt oxide in Example 1; and FIG. 4b is a distribution diagram of the La element of the coated lithium cobalt oxide in Example 1.

FIG. 5a and FIG. 5b are high-power transmission electron microscope (TEM) images of the coated lithium cobalt oxide in Example 1.

FIG. 6 is a cycle performance comparison diagram of the coated lithium cobalt oxide in Example 1 and the uncoated lithium cobalt oxide in Comparative Example 1 respectively as a cathode material for a lithium-ion battery.

FIG. 7 is an EIS impedance test chart of the coated lithium cobalt oxide in Example 1 and the uncoated lithium cobalt oxide in Comparative Example 1 respectively as a cathode material for a lithium-ion battery.

### DETAILED DESCRIPTION

The embodiments of the present application will be described in detail below. Throughout the specification, the same or similar components and components having the same or similar functions are denoted by like reference numerals. The embodiments described herein with respect to the drawings are illustrative and graphical, and are provided to provide a basic understanding of the present application. The embodiments of the present application should not be construed as limiting the present application.

As used herein, the terms “approximately”, “substantially”, “generally” and “about” are used to describe and explain minor changes. When used in conjunction with an event or situation, the terms may refer to examples where the event or situation occurs exactly and examples where the event or situation occurs very closely. For example, when used in conjunction with a numerical value, the terms may refer to a variation range that is less than or equal to ±10% of the numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, if the difference between two numerical values is less than or equal to ±10% of the average of the values (e.g., less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%), the two numerical values may be considered “substantially” the same.

In addition, amounts, ratios, and other numerical values are sometimes presented herein in a range format. It should be understood that such range formats are for convenience and brevity, and should be interpreted with flexibility, and include not only those numerical values that are specifically designated as range limitations, but also include all individual numerical values or sub-ranges that are within the range, as each value and sub-range is specified explicitly.

In detailed descriptions and claims, a list of items connected by the terms “one of” or other similar terms may mean any one of the listed items. For example, if items A and B are listed, then the phrase “one of A and B” means only A or only B. In another example, if items A, B, and C are listed, then the phrase “one of A, B and C” means only A; only B; or only C. The item A may include a single component or multiple components. The item B may include a single component or multiple components. The item C may include a single component or multiple components.

In detailed descriptions and claims, a list of items connected by the terms “at least one of” or other similar terms may mean any combination of the listed items. For example, if items A and B are listed, then the phrase “at least one of A and B” means only A; only B; or A and B. In another example, if items A, B and C are listed, then the phrase “at least one of A, B and C” means only A; or only B; only C; A and B (excluding C); A and C (excluding B); B and C (excluding A); or all of A, B and C. The item A may include a single component or multiple components. The item B may include a single component or multiple components. The item C may include a single component or multiple components.

The embodiments of the present application further provide an electrochemical device including the cathode material of the present application. In some embodiments, the electrochemical device is a lithium-ion battery.

In general, the lithium-ion battery includes a cathode composed of a lithium-containing metal oxide as a cathode active substance and an anode composed of a carbon material as an anode active substance. The electrodes are isolated from each other via a separator, and the separator is typically a microporous polymer membrane that permits the exchange of lithium ions between the two electrodes rather than the exchange of electrons.

A variety of parameters can be used to monitor the performance of lithium-ion batteries, for example: specific energy, volumetric energy, specific capacity, cycle ability, safety, abuse tolerance, and charge/discharge rate. For example, the specific energy (Wh/kg) measures the amount of energy that can be stored and released per unit mass in a battery, which is determined by the product of the specific capacity (Ah/kg) and the operating battery voltage (V). The specific capacity measures the amount of electricity that can be reversibly stored per unit mass, which is closely related to the amount of electrons released from the electrochemical reaction and the atomic amount of the carrier. The cycle ability measures the reversibility of intercalation and deintercalation processes of lithium ions, which is the number of charge and discharge cycles before the battery is significantly depleted of energy or cannot maintain the operation of its powered device. In fact, in addition to battery chemistry, the depth of discharge (DOD) and state of charge (SOC), as well as the operating temperature, can affect the cycle ability of lithium-ion batteries. The shallower discharge depth cycle, the less amplitude of state of charge and avoiding of temperature rise can improve the cycle ability. The rate performance, or more specifically the “discharge/charge rate” (also known as the charge rate (C-rate)), is used to measure the rate at which the battery can be discharged or charged. For example, 1 C represents the battery being discharged from the highest capacity to fully discharged within one hour. A typical lithium-ion battery having a carbon-containing anode material used in personal mobile devices takes about 1 to about 4 hours to return to a fully charged state. Although the battery can be quickly charged to a lower state of charge at a high current by a special charging device, the lithium-ion battery used in electric vehicles usually takes longer to be fully charged, taking as much as a whole night.

In the past two decades, there have been a large number of active research activities in all areas of lithium-ion batteries, from cathodes, anodes, separators, electrolytes, safety, thermal control and packaging, to cell construction and battery management, to improve the overall performance and safety. Among them, the electrode material is the key to the performance of the lithium-ion battery, because the cell voltage, capacitance and cycle ability as well as the total amount of free energy change are generally determined by the electrode material and the above characteristics are based on the fact that the electrochemical reaction at the two electrodes depends on the materials selected for the two electrodes.

### I. CATHODE MATERIAL

In order to meet the demand for high energy density of lithium-ion batteries, the voltage platform of lithium-ion batteries has been repeatedly enhanced. However, as the voltage increases, the side reaction between the cathode material and the electrolyte becomes more serious, and the surface layer of the cathode material particles undergoes a phase change and is deactivated, resulting in an increase in impedance and a loss in capacity. In addition, the electrolyte may oxidize on the surface of the cathode material to form by-products and adhere to the surface of the cathode material, further resulting in an increase in impedance and rapid decay in capacity of the cathode material. Therefore, it is important to improve the stability of the surface of the cathode material while increasing the energy density of the lithium-ion battery.

In the prior art, the surface of the cathode material may be coated to improve the stability of the surface of the cathode material. The coating layer can appropriately isolate the contact between the surface of the cathode material and the electrolyte and inhibit the side reaction between the surface of the cathode material and the electrolyte, thereby improving the surface stability of the cathode material.

Commonly used coating materials are mainly metal oxides such as oxides of Al, Mg and Ti. However, metal oxides are generally non-electrochemically active and cannot intercalate and deintercalate lithium ions, thus causing a decrease in the capacity of the cathode material. In addition, when the cathode material is coated with a large amount of coating material, the intercalation or deintercalation of lithium ions is hindered, thereby increasing the impedance of the material and affecting the rate performance of the cathode material. In addition, coating the cathode active substance with graphene is an effective means for reducing the impedance of the cathode material. However, graphene coating still causes a decrease in the energy density of the cathode material. In addition, the cost of graphene itself is high, and the experimental conditions are demanding (for example, coating experiments require high-temperature sintering in an inert gas atmosphere), which significantly increases the cost and is not conducive to industrial production.

In order to overcome the defects in the prior art, the present application simultaneously studies the cathode active substance and the coating material, and aims to obtain a cathode material which has high energy density, high cycle stability and low impedance and is easy for industrial production.

In some embodiments, the present application selects a cathode active substance containing a Co element and capable of intercalating and deintercalating lithium ions as a substrate of the cathode material, and selects a fast lithium ion conductor material containing a Co element as a coating layer of the cathode material, wherein the general formula of the fast lithium ion conductor material containing the Co element is expressed as LaₓLi_{y}Co_{z}Oₐ, wherein 1≤x≤2, 0<y≤1, 0<z≤1, 3≤a≤4 and 3x+y+3z=2a.

In the synthesized cathode material, the fast lithium ion conductor material coating layer not only can realize the functions of the conventional coating layer (i.e., isolating the cathode active substance from the electrolyte, and effectively reducing the side reaction between the cathode active substance and the electrolyte), but also can promote the transport and diffusion of lithium ions and reduce the impedance of the cathode material itself, thereby improving the rate performance of the cathode material. In addition, the above fast lithium ion conductor material coating layer containing the Co element is also electrochemically active, is capable of intercalating and deintercalating lithium ions, and can improve the stability and impedance characteristics of the cathode material without sacrificing the energy density of the cathode material.

In addition, it is also worth noting that the present application introduces the Co element simultaneously in the substrate and coating layer of the cathode material, in order to achieve better compatibility between the coating layer and the substrate and promote the formation of a solid solution between the substrate and the coating layer. The formation of the solid solution helps to: 1) enhance the association between the substrate and the coating layer such that the coating layer is more strongly attached to the surface of the substrate; 2) stabilize the surface structure of the cathode material and improve the interface characteristics of the cathode material; and 3) construct an effective lithium ion channel, promote the transport and diffusion of lithium ions and improve the rate performance of the cathode material.

In some embodiments, the mass fraction of LaₓLi_{y}Co_{z}Oₐ in the cathode material is from about 0.01% to about 15%, from about 0.01% to about 10%, from about 0.01% to about 5% or from about 0.2% to about 2%. When the coating amount of LaₓLi_{y}Co_{z}Oₐ is too small, it is not sufficient to improve the impedance characteristics and stability of the cathode material. When the coating amount of LaₓLi_{y}Co_{z}Oₐ is too high, the effects of improving the impedance characteristics and stability of the cathode material will not be significant any more.

Appropriately increasing the content of the La element in the coating layer LaₓLi_{y}Co_{z}Oₐ contributes to further improvement of the electrochemical performance of the cathode material. In some embodiments, the composition of LaₓLi_{y}Co_{z}Oₐ may be “1.5≤x≤2, 0<y≤0.5, 0<z≤0.5 and 3.5≤a≤4”. In another embodiment, the coating layer is La₂Li_{0.5}Co_{0.5}O₄.

The cathode active substance includes a lithium-containing transition metal oxide containing a cobalt element, and the lithium-containing transition metal oxide may include, but is not limited to, one or more of lithium cobalt oxide, lithium nickel cobalt manganese oxide and lithium nickel cobalt aluminum oxide. In some embodiments, the cathode active substance may be lithium cobalt oxide or doping-modified lithium cobalt oxide, and the general formula may be expressed as Li_{c}Co_{d}Mi_{1-d}O₂, wherein M includes at least one of Co, Ni, Mn, Al, Mg, Ti, Zr, F, Y, Nb, La, B, Mo, V or Ce, wherein 0.95≤c≤1.05 and 0.95≤d≤0.9999. In some embodiments, the cathode active substance may also be a cobalt nickel manganese ternary material or a doping-modified cobalt nickel manganese ternary material, wherein the general formula of the cobalt nickel manganese ternary material may be expressed as Li₁₊ₑCo_{f}Ni_{g}Mn_{1-f-g}MᵥO₂, wherein M includes one or more of Co, Ni, Mn, Al, Mg, Ti, Zr, F, Y, Nb, La, B, Mo, V or Ce, wherein 0≤e<0.2, g<1, f+g<1 and 0≤v<0.05.

The average particle diameter and specific surface area of the cathode active substance and the coated cathode material are not particularly limited in the present application. The “average particle diameter” herein refers to the median particle diameter Dv50, which is the particle diameter value of the cathode material particles at 50% in the cumulative distribution curve (the cumulative distribution curve shows the particle diameter of the smallest particle to the largest particle). When the median particle diameter Dv50 is too small, the cathode material particles may excessively react with the electrolyte, resulting in deterioration of the cycle stability and rate performance. However, when the median particle diameter Dv50 is too large, the active specific surface area of the cathode material particles will decrease, and the active sites which can participate in the electrochemical reaction will be reduced, making it difficult to achieve high energy density.

In some embodiments of the present application, the median particle diameter Dv50 of the coated cathode material may be in the range of about 2 μm to about 40 μm, in the range of about 4 μm to about 30 μm, in the range of about 4 μm to about 22 μm or in the range of about 8 μm to about 18 μm. In the present application, the data of the median particle diameter Dv50 of the cathode material is measured by a Malvern Master Size 3000 average particle size measuring device. For the test method, refer to GB/T-19077-2016.

The specific surface area of the cathode material is related to its average particle diameter. For example, as the average particle diameter of the cathode material is smaller, the specific surface area thereof will be larger; and as the average particle diameter of the cathode material is larger, the specific surface area thereof will be smaller. In some embodiments of the present application, the specific surface area of the coated cathode material may be about 0.08 m²/g to about 0.4 m²/g or about 0.1 m²/g to about 0.3 m²/g. In the present application, the specific surface area of the cathode material is measured using a Micromeritics Tristar3020 BET test device. For the test method, refer to GB/T 19587-2017.

### II. PREPARATION METHOD OF CATHODE MATERIAL

The embodiments of the present application also provide a method for preparing the cathode material of the above embodiments. The preparation method is simple and easy to operate, controllable in reaction conditions and suitable for industrial production, and has broad commercial application prospects.

In general, the present application applies a sol-gel process so that the surface of a cathode active substance containing a cobalt element and capable of intercalating and deintercalating lithium ions is uniformly coated with a lanthanum salt, a lithium salt and a cobalt salt to obtain a cathode active material gel precursor; and the gel precursor is mixed and sintered under a certain atmosphere to obtain the cathode material having the coating layer LaₓLi_{y}Co_{z}Oₐ.

In the high-temperature sintering process, the lanthanum salt, the lithium salt and the cobalt salt undergo a solid solution reaction to produce a LaₓLi_{y}Co_{z}Oₐ solid solution, and the surface of the cathode material is uniformly coated with the solid solution, which can stabilize the surface structure of the lithium cobalt oxide and inhibit the side reaction between the cathode active substance and the electrolyte, thereby improving the cycle stability of the cathode material. Moreover, the LaₓLi_{y}Co_{z}Oₐ solid solution is a lithium ion conductor with high lithium ion transport characteristics, which can reduce the surface impedance of the cathode material and improve its rate performance.

Specifically, the preparation method of the above cathode material may include the following three steps:

(1) dispersing a lanthanum salt, a lithium salt and a cobalt salt in an organic solution, adding a complexing agent, stirring uniformly and removing the organic solution to obtain a LaₓLi_{y}Co_{z}Oₐ sol;

(2) mixing the LaₓLi_{y}Co_{z}Oₐ sol with a cathode active substance containing a cobalt element and capable of intercalating and deintercalating lithium ions, and drying at a drying temperature to obtain a gel precursor; and

(3) mixing and sintering the gel precursor to obtain the cathode material.

In some embodiments, according to the preparation method described above, in step (1), the composition of the LaₓLi_{y}Co_{z}Oₐ sol is adjusted by adjusting the molar ratio of the lanthanum salt to the lithium salt to the cobalt salt, thereby adjusting the composition of the coating layer LaₓLi_{y}Co_{z}Oₐ in the finally obtained cathode material. For example, in some embodiments, by adjusting the molar ratio of the lanthanum salt to the lithium salt to the cobalt salt, the composition of the coating layer LaₓLi_{y}Co_{z}Oₐ can be 1≤x≤2, 0<y≤1, 0<z≤1 and 3≤a≤4. For example, in some embodiments, by adjusting the molar ratio of the lanthanum salt, the lithium salt and the cobalt salt, the composition of the coating layer LaₓLi_{y}Co_{z}Oₐ can be 1.5≤x≤2, 0<y≤0.5, 0<z≤0.5 and 3.5≤a≤4.

In some embodiments, according to the preparation method described above, in step (1), the ratio of the molar amount of the complexing agent to the sum of the molar amounts of the lanthanum salt, the lithium salt and the cobalt salt is about (0.5-3.5): 1, about (1.0-2.5): 1, about (1.0-1.5):1 or about (1.1-1.3):1.

In some embodiments, according to the preparation method described above, in step (1), the lanthanum salt is at least one of La(NO₃)₃ or LaCl₃.

In some embodiments, the lithium salt includes at least one of LiOH or Li₂CO₃.

In some embodiments, the cobalt salt includes at least one of CoCl₂, CoSO₄, Co(NO₃)₂, Co(CH₃COO)₂ or CoC₂O₄.

In some embodiments, according to the preparation method described above, in step (1), the organic solution may include at least one of ethanol or methanol.

In some embodiments, according to the preparation method described above, in step (1), the complexing agent includes at least one of citric acid, β-hydroxybutyric acid, tartaric acid, phthalic acid, α-naphthalene acetic acid or diethylenetriaminepentaacetic acid.

In some embodiments, according to the preparation method described above, the mass fraction of LaₓLi_{y}Co_{z}Oₐ in the finally obtained cathode material can be adjusted by adjusting the mass ratio of LaₓLi_{y}Co_{z}Oₐ to the cathode active substance. For example, in some embodiments, by adjusting the mass ratio of LaₓLi_{y}Co_{z}Oₐ to the cathode active substance, the mass fraction of LaₓLi_{y}Co_{z}Oₐ to the cathode material can be about 0.01% to about 15%, about 0.01% to about 10%, about 0.01% to about 5% or about 0.2% to about 2%.

In some embodiments, according to the preparation method described above, in step (2), the drying temperature is from about 80° C. to about 200° C. or from about 120° C. to about 150° C.

In some embodiments, according to the preparation method described above, in step (2), the drying time is from about 8 h to about 24 h or from about 12 h to about 18 h.

In some embodiments, according to the preparation method described above, in step (2), the LaₓLi_{y}Co_{z}Oₐ sol may be mixed with the cathode active substance in one or more of ball milling, grinding and magnetic stirring.

In some embodiments, according to the preparation method described above, in step (3), the sintering temperature is from about 300° C. to about 1100° C., from about 300° C. to about 1000° C., from about 400° C. to about 900° C. or from about 600 to about 800° C.

In some embodiments, according to the preparation method described above, in step (3), the sintering time is from about 2 h to about 15 h, from about 2 h to about 12 h, from about 3 h to about 12 h or from about 5 h to about 7 h.

In some embodiments, according to the preparation method described above, in step (3), the temperature rise rate of the mixing and sintering is from about 2° C. to about 15° C. per minute, from about 2° C. to about 10° C. per minute, from about 3° C. to about 8° C. per minute or from about 4° C. to about 6° C. per minute.

In some embodiments, according to the preparation method described above, in step (3), the atmosphere for mixing and sintering is oxygen or air.

In some embodiments, the cathode active substance includes a lithium-containing transition metal oxide containing a cobalt element, and the lithium-containing transition metal oxide may include, but is not limited to, one or more of lithium cobalt oxide, lithium nickel cobalt manganese oxide and lithium nickel cobalt aluminum oxide. In some embodiments of the present application, the cathode active substance may be lithium cobalt oxide or doping-modified lithium cobalt oxide, and the general formula may be expressed as Li_{c}Co_{d}M_{1-d}o₂, wherein M includes at least one of Co, Ni, Mn, Al, Mg, Ti, Zr, F, Y, Nb, La, B, Mo, V or Ce, wherein 0.95≤c≤1.05 and 0.95≤d≤0.9999. In some embodiments, the cathode active substance may also be a cobalt nickel manganese ternary material, wherein the general formula of the cobalt nickel manganese ternary material may be expressed as Li₁₊ₑCo_{f}Ni_{g}Mn_{1-f-g}MᵥO₂, wherein M includes one or more of Co, Ni, Mn, Al, Mg, Ti, Zr, F, Y, Nb, La, B, Mo, V or Ce, wherein 0≤e<0.2, g<1, f+g<1 and 0≤v<0.05.

### III. ELECTROCHEMICAL DEVICE

The embodiments of the present application further provide an electrochemical device including the cathode material of the present application. In some embodiments, the electrochemical device is a lithium-ion battery. The lithium-ion battery includes a cathode containing the cathode material of the present application, an anode containing an anode material, a separator and an electrolyte, wherein the cathode of the present application includes a cathode active substance layer formed on the surface of a cathode current collector, wherein the cathode active substance layer contains the above cathode material. In some embodiments of the present application, the cathode current collector may be, but not limited to, aluminum foil or nickel foil, and the anode current collector may be, but not limited to, copper foil or nickel foil.

The anode includes an anode material capable of absorbing and releasing lithium (Li) (hereinafter, sometimes referred to as “an anode material capable of absorbing/releasing lithium (Li)”). Examples of the anode material capable of absorbing/releasing lithium (Li) may include carbon materials, metal compounds, oxides, sulfides, nitrides of lithium such as LiN₃, lithium metal, metals forming alloys together with lithium, and polymer materials.

Examples of the carbon material may include low graphitized carbon, easily graphitizable carbon, artificial graphite, natural graphite, mesophase carbon microspheres, soft carbon, hard carbon, pyrolytic carbon, coke, vitreous carbon, organic polymer compound sintered bodies, carbon fibers and activated carbon, wherein the coke may include pitch coke, needle coke and petroleum coke. The organic polymer compound sintered body refers to a material obtained by calcining a polymer material such as a phenol plastic or a furan resin at a suitable temperature to carbonize same, and some of these materials are classified into low graphitized carbon or easily graphitizable carbon. Examples of the polymer material may include polyacetylene and polypyrrole.

Among these anode materials capable of absorbing/releasing lithium (Li), further, a material whose charge and discharge voltages are close to the charge and discharge voltages of lithium metal is selected. This is because the lower the charge and discharge voltages of the anode material, the easier the lithium-ion battery has a higher energy density, wherein the anode material may be carbon materials because their crystal structures are only slightly changed during charging and discharging, and therefore, good cycle performance and large charge and discharge capacities can be obtained. In particular, graphite may be selected because it gives a large electrochemical equivalent and a high energy density.

Further, the anode material capable of absorbing/releasing lithium (Li) may include elemental lithium metal, metal elements and semimetal elements capable of forming alloys together with lithium (Li), alloys and compounds including such elements, and the like. In particular, they are used together with carbon materials since good cycle performance and high energy density can be obtained therefrom. In addition to the alloys including two or more metal elements, the alloys used herein also include alloys containing one or more metal elements and one or more semimetal elements. The alloy may be in the form of a solid solution, a eutectic crystal (eutectic mixture), an intermetallic compound, and a mixture thereof.

Examples of the metal elements and the semimetal elements may include tin (Sn), lead (Pb), aluminum (Al), indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y) and hafnium (Hf). Examples of the above alloys and compounds may include a material having a chemical formula: MaₛMbₜLiᵤ and a material having a chemical formula: MaₚMc_{q}Mdᵣ. In these chemical formulae, Ma represents at least one of the metal elements or semimetal elements capable of forming an alloy together with lithium; Mb represents at least one of the metal elements or semimetal elements other than lithium and Ma; Mc represents at least one of the non-metal elements; Md represents at least one of the metal elements or semimetal elements other than Ma; and s, t, u, p, q and r satisfy s>0, t≥0, u≥0, p>0, q>0 and r≥0.

In addition, an inorganic compound not including lithium (Li), such as MnO₂, V₂O₅, V₆O₁₃, NiS and MoS, may be used in the anode.

The above lithium-ion battery further includes an electrolyte, the electrolyte may be one or more of a gel electrolyte, a solid electrolyte and a liquid electrolyte, and the liquid electrolyte includes a lithium salt and a non-aqueous solvent.

The lithium salt is one or more selected from LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB and lithium difluoroborate. For example, the lithium salt is LiPF₆ because it can give a high ionic conductivity and improve the cycle performance.

The non-aqueous solvent may be a carbonate compound, a carboxylate compound, an ether compound, other organic solvents, or a combination thereof.

The carbonate compound may be a chain carbonate compound, a cyclic carbonate compound, a fluorocarbonate compound, or a combination thereof.

Examples of the chain carbonate compound are diethyl carbonate (DEC), dimethyl carbonate (DMC), dipropyl carbonate (DPC), methylpropyl carbonate (MPC), ethylpropyl carbonate (EPC), methylethyl carbonate (MEC) and combinations thereof. Examples of the cyclic carbonate compound are ethylene carbonate (EC), propylene carbonate (PC), butylene carbonate (BC), vinyl ethylene carbonate (VEC), propyl propionate (PP) and combinations thereof. Examples of the fluorocarbonate compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate and combinations thereof.

Examples of the carboxylate compound are methyl acetate, ethyl acetate, n-propyl acetate, t-butyl acetate, methyl propionate, ethyl propionate, γ-butyrolactone, decalactone, valerolactone, mevalonolactone, caprolactone, methyl formate and combinations thereof.

Examples of the ether compound are dibutyl ether, tetraethylene glycol dimethyl ether, diglyme, 1,2-dimethoxyethane, 1,2-diethoxyethane, ethoxy methoxyethane, 2-methyltetrahydrofuran, tetrahydrofuran and combinations thereof.

Examples of other organic solvents are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate and combinations thereof.

According to the embodiments of the present application, the lithium-ion battery further includes a separator, and when the lithium ions in the electrolyte are allowed to pass through the separator in the lithium-ion battery, the separator in the lithium-ion battery avoids direct physical contact between the anode and the cathode and prevents the occurrence of a short circuit. The separator is typically made of a material that is chemically stable and inert when in contact with the electrolyte and the electrodes. At the same time, the separator needs to be mechanically robust to withstand the stretching and piercing of the electrode material, and the pore size of the separator is typically less than 1 micron. Various separators, including microporous polymer membranes, non-woven mats and inorganic membranes, have been used in lithium-ion batteries, and the polymer membranes based on microporous polyolefin materials are the most commonly used separators in combination with liquid electrolytes. The microporous polymer membranes can be made very thin (typically about 25 μm) and highly porous (typically about 40%) to reduce electrical resistance and increase ion conductivity. At the same time, the polymer membrane still has mechanical robustness. Those skilled in the art will appreciate that various separators widely used in lithium-ion batteries are suitable for use in the present application.

Although the lithium-ion battery is adopted for exemplification, those skilled in the art, after reading the present application, can imagine that the cathode material of the present application can be used in other suitable electrochemical devices. Such electrochemical devices include any device that generates an electrochemical reaction, and its specific examples include all kinds of primary batteries, secondary batteries, fuel cells, solar cells, or capacitors. In particular, the electrochemical device is a lithium secondary battery, including a lithium metal secondary battery, a lithium-ion secondary battery, a lithium polymer secondary battery or a lithium-ion polymer secondary battery.

### IV. APPLICATIONS

The electrochemical device produced from the cathode material of the present application is suitable for electronic devices in various fields.

The use of the electrochemical device of the present application is not particularly limited and can be used in any use known in the art. In one embodiment, the electrochemical device of the present application may be used for, but not limited to, notebook computers, pen input computers, mobile computers, e-book players, portable phones, portable fax machines, portable copy machines, portable printers, stereo headphones, video recorders, liquid crystal display televisions, portable cleaners, portable CD players, mini disk players, transceivers, electronic notebooks, calculators, memory cards, portable recorders, radios, backup power devices, motors, cars, motorcycles, power bicycles, bicycles, lighting fixtures, toys, game consoles, clocks, electric tools, flash lamps, cameras, large household batteries, lithium-ion capacitors and the like.

Hereinafter, a lithium-ion battery is taken as an example and combined with a specific embodiment for preparing a cathode material of the present application and a measuring method for an electrochemical device to explain the preparation and performance of the lithium-ion battery of the present application. Those skilled in the art will appreciate that the preparation methods described in the present application are merely examples, and any other suitable preparation method is within the scope of the present application.

### V. EXAMPLES

### Preparation of Lithium-Ion Battery

The cathode materials in the examples and the comparative examples were applied into lithium-ion batteries by the following preparation methods. Specifically, the cathode material prepared in the following examples and comparative examples, a conductive agent, acetylene black and a binder polyvinylidene fluoride (PVDF) were sufficiently stirred and uniformly mixed in a weight ratio of 94:3:3 in an N-methylpyrrolidone system to form a cathode slurry, then the front and back surfaces of a cathode current collector aluminum foil were uniformly coated with the obtained cathode slurry, drying was performed at 85° C. to obtain cathode active material layers, and cold pressing, slitting, slice cutting and welding of the cathode tab were performed to obtain a cathode.

An anode active substance artificial graphite, a thickener sodium carboxymethylcellulose (CMC) and a binder styrene-butadiene rubber (SBR) were thoroughly stirred and uniformly mixed in a weight ratio of 98:1:1 in a deionized water system to form an anode slurry, the front and back surfaces of an anode current collector copper foil were uniformly coated with the anode slurry, drying was performed at 85° C. to form an anode active material layer, and cold pressing, slitting, slice cutting and welding of the anode tab were performed to obtain an anode.

A solution prepared from a lithium salt LiPF₆ and a non-aqueous organic solvent (ethylene carbonate (EC):diethyl carbonate (DEC):propylene carbonate (PC):propyl propionate (PP):vinylene carbonate (VC)=20:30:20:28:2, mass ratio) in a mass ratio of 8:92 was used as an electrolyte of the lithium-ion battery.

A ceramic-coated polyethylene (PE) material separator was used as the separator.

The cathode, the separator and the anode were stacked in order, so that the separator was located between the cathode and the anode to function as an isolator. The electrode assembly was placed in a package, the electrolyte was injected, packaging was performed, and then formation was performed to prepare the final lithium-ion battery.

### Test Methods of Lithium-Ion Battery

The prepared lithium-ion battery was tested as follows, and the test conditions were as follows:

### (1) Specific Capacity Test

At 25° C., the lithium-ion battery was charged at a constant current of 0.2 C to a cut-off voltage of 4.45 V, and then charged at a constant voltage of 4.45 V to a current of 0.025 C to obtain a charge capacity. After standing for 5 min, the battery was discharged at a constant current of 0.2 C to a voltage of 3.0 V to obtain a discharge capacity. Charge specific capacity =charge capacity/mass of cathode material; and discharge specific capacity =discharge capacity/mass of cathode material.

### (2) EIS Impedance Test

At 25° C., the lithium-ion battery was charged at a current of 0.5 C to a cut-off voltage of 3.85 V, and then charged at a constant voltage of 3.85 V to a current of 0.025 C. After standing for 5 min, the EIS was tested.

### (3) High-Temperature Storage Test

At 25° C., the lithium-ion battery was charged at a current of 0.5 C to a cut-off voltage of 4.45 V, and then charged at a constant voltage of 4.45 V to a current of 0.05 C such that the battery was in a 4.45 V fully charged state. The thickness of the fully charged battery before storage was tested and recorded as D₀. The fully charged battery was placed in a 60° C. oven. After twenty-one days, the battery was taken out, and the thickness after storage was immediately tested and recorded as Di. The thickness expansion ratio of the battery before and after storage was calculated according to the following formula:

ε=(D₁−D₀)/D₀×100%.

### (4) Cycle Performance Test

The lithium-ion battery was repeatedly charged and discharged by the following steps, and the discharge capacity retention rate of the lithium-ion battery was calculated.

Firstly, the battery was subjected to first charge and discharge at 25° C. Specifically, the battery was charged at a constant current of 0.5 C to 4.45 V, charged at the constant voltage to 0.025 C, allowed to stand for 5 min and discharged at a constant current of 0.5 C to 3.0 V, and the first cycle discharge capacity value was recorded. Then, 800 cycles of charge and discharge were performed, the discharge capacity value at the 800th cycle was recorded, and the cycle capacity retention rate was calculated using the following formula:

Cycle capacity retention rate=(discharge capacity at 800^{th} cycle/discharge capacity at first cycle)×100%.

Specific implementations of the cathode material provided by the present application will be described in detail below.

### 1. Examples 1 to 6 and Comparative Example 1

### Example 1

The preparation method of the cathode material of Example 1 is as follows: firstly, 32.5 g of La(NO₃)₃, 0.8 g of Li₂CO₃ and 3.2 g of CoCl₂ were respectively weighed according to the molar ratio of 2:0.5:0.5 and added into a beaker, 200 mL of absolute ethanol was poured and stirred uniformly, 31.7 g of citric acid was added and stirred uniformly, and after the ethanol solution was removed, a sol was obtained; secondly, the obtained sol and 8.5 kg of lithium cobalt oxide were mixed thoroughly and uniformly by ball milling and dried; and finally, the mixture was mixed and fired in an air atmosphere at 700° C. for 7 hours, and pulverized and sieved to obtain a surface-modified lithium cobalt oxide cathode material.

### Examples 2-6

The coating material was prepared in the same manner as in Example 1, but the molar ratio of La:Li:Co was controlled to be 1:0.1:1, 1.5:0.5:0.5, 1:0.5:0.5, 1.5:0.5:1 and 1:0.5:1, respectively.

### Comparative Example 1

### Uncoated Lithium Cobalt Oxide

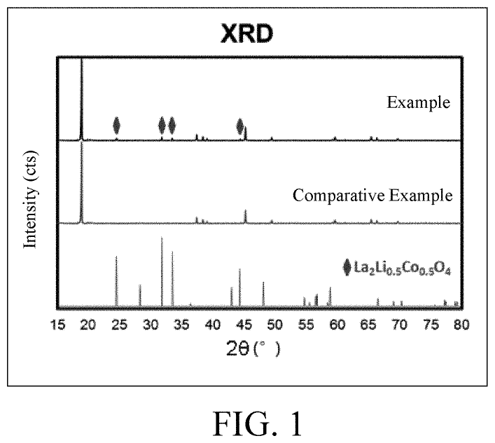

FIG. 1 of the present application is an X-ray diffraction (XRD) pattern respectively showing the coated lithium cobalt oxide in Example 1, the uncoated lithium cobalt oxide in Comparative Example 1, and La₂Li_{0.5}Co_{0.5}o₄. As can be seen from the XRD pattern, the composite of LiCoO₂ and La₂Li_{0.5}Co_{0.5}O₄ was synthesized in Example 1 of the present application.

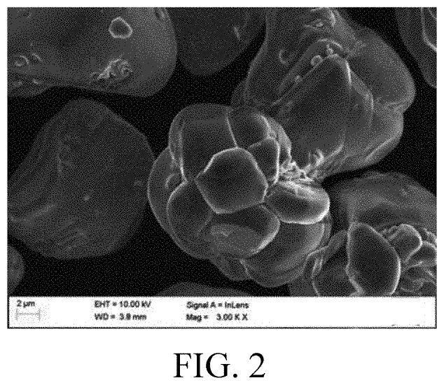

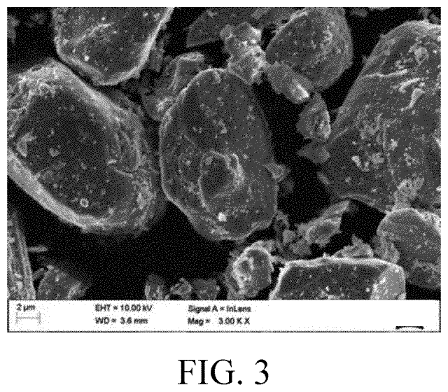

FIG. 2 and FIG. 3 respectively show the SEM images of the uncoated lithium cobalt oxide in Comparative Example 1 and the coated lithium cobalt oxide in Example 1. As can be seen from FIG. 2, the surface of the lithium cobalt oxide without any coating is smooth, whereas as can be seen from FIG. 3, the surface of the coated lithium cobalt oxide becomes rough, and a large amount of particles La₂Li_{0.5}Co_{0.5}O₄ is attached to the surface of the LiCoO₂ substrate.

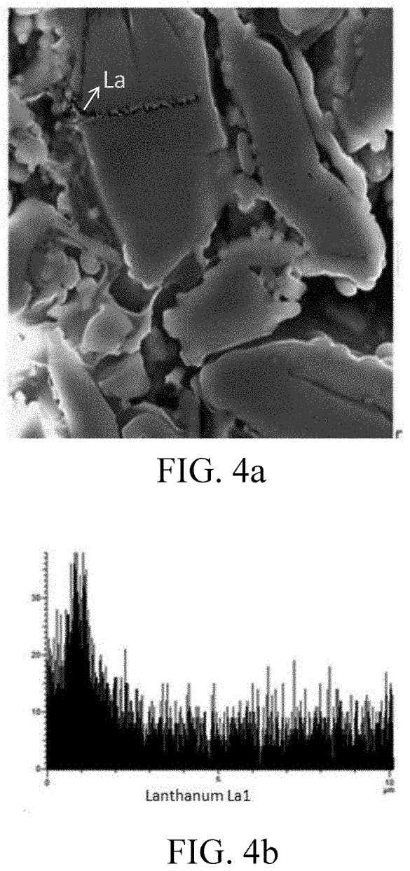

FIG. 4a is a cross-sectional SEM image of the coated lithium cobalt oxide in Example 1, and FIG. 4b is a cross-sectional distribution diagram of the La element in the coated lithium cobalt oxide. As can be seen from FIG. 4a and FIG. 4b, the La element is mainly distributed on the surface of the cathode material, and the La signal at the internal of the material is mainly caused by the signal-to-noise ratio of the test instrument itself.

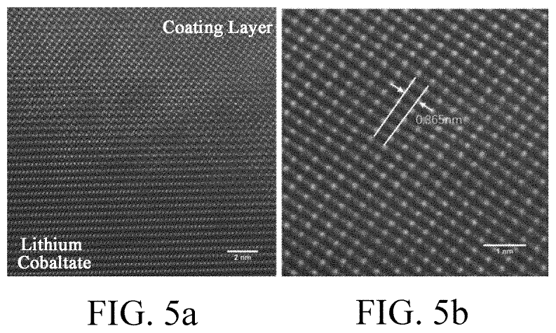

FIG. 5a is a TEM image of the interface portion of the substrate LiCoO₂ and the coating layer La₂Li_{0.5}Co_{0.5}O₄ of the cathode material, and FIG. 5b is a high-power TEM image of the coating layer. As can be seen from FIG. 5a, there is no clear interface between the LiCoO₂ substrate and the La₂Li_{0.5}Co_{0.5}O₄ coating layer, and a solid solution is formed between the substrate and the coating layer. As can be seen from FIG. 5b, the lattice spacing (0.365 nm) coincides with the 101 interplanar spacing (0.362 nm) of La₂Li_{0.5}Co_{0.5}O₄, which proves the existence of the coating layer La₂Li_{0.5}Co_{0.5}O₄.

According to the above characterization means, in Example 1 of the present application, a cathode material LiCoO₂.La₂Li_{0.5}Co_{0.5}O₄ having a substrate of LiCoO₂ and a coating layer of La₂Li_{0.5}Co_{0.5}O₄ was synthesized, wherein a solid solution was formed at the interface between the LiCoO₂ substrate and the La₂Li_{0.5}Co_{0.5}O₄ coating layer.

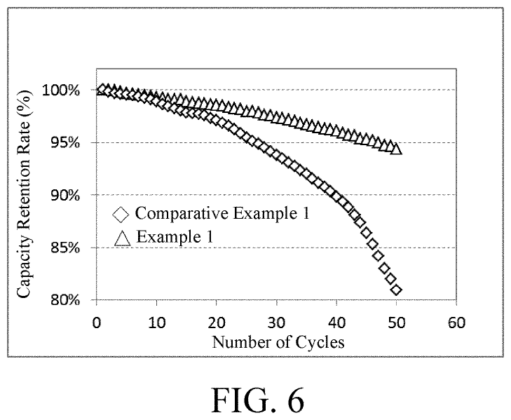

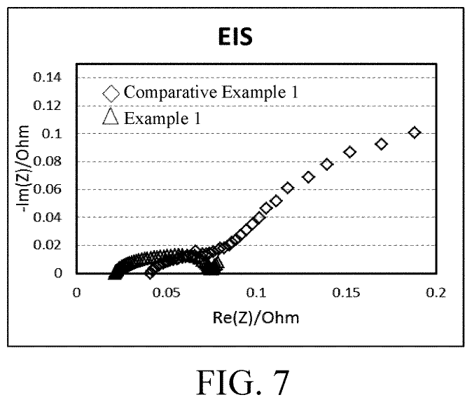

FIG. 6 and FIG. 7 are respectively a cycle performance diagram and an EIS impedance test chart of the cathode materials obtained in Comparative Example 1 and Example 1. As can be seen from FIG. 6, the coated cathode material (LiCoO₂.La₂Li_{0.5}Co_{0.5}O₄) obtained in Example 1 has better cycle stability. As can be seen from FIG. 7, the coated cathode material (LiCoO₂.La₂Li_{0.5}C_{0.5}O₄) obtained in Example 1 has a smaller impedance and is more favorable for the diffusion and transport of lithium ions.

Further, Table 1 shows the electrochemical data of Examples 1 to 6 and Comparative Example 1 respectively.

TABLE 1

| | | | | | | | | 800 cls, |
|---|---|---|---|---|---|---|---|---|
| | | | | | | | 60° C. | 25° C. |
| | | | | | | | Storage | Cycle |
| | | La/Li/Co | Charge | Discharge | | EIS | 21D | Capacity |
| | | Molar | Specific | Specific | First | Rct | Expansion | Retention |
| | Substrate | Ratio | Capacity | Capacity | Efficiency | (ohm) | Ratio | Rate |
| Example 1 | LiCoO₂ | 2/0.5/0.5 | 195.9 | 180.7 | 92.2% | 0.08 | 10.0% | 80.0% |
| Example 2 | LiCoO₂ | 1/0.1/1 | 196.1 | 180.9 | 92.2% | 0.12 | 8.9% | 81.1% |
| Example 3 | LiCoO₂ | 1.5/0.5/0.5 | 196.6 | 182.7 | 92.9% | 0.075 | 5.3% | 89.3% |
| Example 4 | LiCoO₂ | 1/0.5/0.5 | 196.3 | 182.0 | 92.7% | 0.142 | 7.3% | 86.6% |
| Example 5 | LiCoO₂ | 1.5/0.5/1 | 196.4 | 181.3 | 92.3% | 0.138 | 9.2% | 83.0% |
| Example 6 | LiCoO₂ | 1/0.5/1 | 196.2 | 181.5 | 92.5% | 0.165 | 12.3% | 82.9% |
| Comparative | LiCoO₂ | / | 196.5 | 182.6 | 92.9% | 0.356 | 51.6% | 21.1% |
| Example 1 | | | | | | | | |

The data in Table 1 shows that, compared with Comparative Example 1, the EIS impedance of the lithium-ion battery prepared by the cathode materials of Examples 1 to 6 was significantly lower, and the material stability and cycle stability at high temperatures were also significantly improved. In addition, the specific capacity of lithium cobalt oxide cathode material coated with the fast lithium ion conductor material was not decreased, and some were even higher, which indicates that the fast lithium ion conductor material coating layer did not lose or sacrifice the specific capacity of the cathode material, but even contributed the specific capacity while improving the impedance characteristics and cycle stability of the cathode material.

### 2. Examples 7 to 11

The coating material was prepared in the same manner as in Example 3, but the ratio of the molar amount of the complexing agent to the sum of the molar amounts of the lanthanum salt, the lithium salt and the cobalt salt was respectively controlled at 1.0:1, 1.1:1, 1.3:1, 1.4:1 and 1.5:1.

Performance tests were performed respectively on Examples 3 and 7-11. The test results are shown in Table 2:

TABLE 2

| | | Molar amount of | | | | | | |
|---|---|---|---|---|---|---|---|---|
| | | the complexing | | | | | | 800 cls, |
| | | agent/sum of molar | | | | | 60° C. | 25° C. |
| | | amounts of | | | | | Storage | Cycle |
| | | lanthanum salt, | Charge | Discharge | | EIS | 21D | Capacity |
| | | lithium salt and | Specific | Specific | First | Rct | Expansion | Retention |
| | Substrate | the cobalt salt | Capacity | Capacity | Efficiency | (ohm) | Ratio | Rate |
| Example 7 | LiCoO₂ | 1.0/1 | 194.5 | 180.4 | 92.8% | 0.123 | 11.5% | 74.9% |
| Example 8 | LiCoO₂ | 1.1/1 | 194.2 | 180.5 | 92.9% | 0.125 | 8.3% | 83.1% |
| Example 3 | LiCoO₂ | 1.2/1 | 196.6 | 182.7 | 92.9% | 0.075 | 5.3% | 89.3% |
| Example 9 | LiCoO₂ | 1:3/1 | 195.6 | 181.1 | 92.6% | 0.098 | 7.8% | 82.8% |
| Example 10 | LiCoO₂ | 1.4/1 | 196.3 | 179.8 | 91.6% | 0.172 | 12.3% | 75.2% |
| Example 11 | LiCoO₂ | 1.5/1 | 195.2 | 178.0 | 91.2% | 0.126 | 11.2% | 80.3% |

From the electrochemical data of Examples 3 and 7 to 11 in Table 2, the batteries of Examples 3 and 7 to 11 all had high specific capacity, low resistance, and good high-temperature stability and cycle stability. Further, as can be seen from Table 2, the electrochemical performance of the cathode material can be further improved by adjusting the ratio of the molar amount of the complexing agent to the sum of the molar amounts of the lanthanum salt, the lithium salt and the cobalt salt in the preparation process. This is because a suitable amount of the complexing agent helps to improve the crystallinity of the coated solid solution and reduce lattice defects, thereby achieving a better coating effect.

### 3. Examples 12 to 16

The coating material was prepared in the same manner as in Example 3, but the sintering temperature was controlled at 550° C., 600° C., 650° C., 750° C. and 800° C., respectively.

Performance tests were performed respectively on Examples 3 and 12 to 16. The test results are shown in Table 3:

TABLE 3

| | | | | | | | | 800 cls, |
|---|---|---|---|---|---|---|---|---|
| | | | | | | | 60° C. | 25° C. |
| | | | | | | | Storage | Cycle |
| | | | Charge | Discharge | | EIS | 21D | Capacity |
| | | Sintering | Specific | Specific | First | Rct | Expansion | Retention |
| | Substrate | Temperature | Capacity | Capacity | Efficiency | (ohm) | Ratio | Rate |
| Example 12 | LiCoO₂ | 550° C. | 194.0 | 179.2 | 92.4% | 0.168 | 15.9% | 74.5% |
| Example 13 | LiCoO₂ | 600° C. | 194.6 | 180.5 | 92.8% | 0.172 | 15.1% | 76.2% |
| Example 14 | LiCoO₂ | 650° C. | 195.2 | 180.6 | 92.5% | 0.132 | 10.3% | 80.4% |
| Example 3 | LiCoO₂ | 700° C. | 196.6 | 182.7 | 92.9% | 0.075 | 5.3% | 89.3% |
| Example 15 | LiCoO₂ | 750° C. | 196.4 | 181.5 | 92.4% | 0.121 | 6.7% | 84.9% |
| Example 16 | LiCoO₂ | 800° C. | 195.1 | 180.2 | 92.4% | 0.109 | 9.0% | 80.6% |

From the electrochemical data of Examples 3 and 12 to 16 in Table 3, the batteries of Examples 3 and 12 to 16 all had high specific capacity, low resistance, and good high-temperature stability and cycle stability. Further, as can be seen from Table 3, the electrochemical performance of the cathode material can be further improved by adjusting the sintering temperature in the preparation process. This is because the appropriate sintering temperature can form a relatively completely solid solution coating layer without affecting the volatilization of Li in the substrate material, thereby exerting the best effect.

### 4. Examples 17 to 21

The coating material was prepared in the same manner as in Example 3, but the sintering time was controlled at 3 h, 4 h, 5 h, 7 h and 8 h, respectively.

Performance tests were performed respectively on Examples 3 and 17 to 21. The test results are shown in Table 4:

TABLE 4

| | | | | | | | | 800 cls, |
|---|---|---|---|---|---|---|---|---|
| | | | | | | | 60° C. | 25° C. |
| | | | | | | | Storage | Cycle |
| | | Sintering | Charge | Discharge | | EIS | 21D | Capacity |
| | | Time | Specific | Specific | First | Rct | Expansion | Retention |
| | Substrate | (h) | Capacity | Capacity | Efficiency | (ohm) | Ratio | Rate |
| Example 17 | LiCoO₂ | 3 | 193.7 | 178.0 | 91.9% | 0.169 | 16.1% | 77.6% |
| Example 18 | LiCoO₂ | 4 | 194.9 | 179.7 | 92.2% | 0.162 | 13.7% | 79.6% |
| Example 19 | LiCoO₂ | 5 | 196.0 | 181.9 | 92.8% | 0.105 | 10.2% | 83.2% |
| Example 3 | LiCoO₂ | 6 | 196.6 | 182.7 | 92.9% | 0.075 | 5.3% | 89.3% |
| Example 20 | LiCoO₂ | 7 | 196.4 | 182.5 | 92.9% | 0.124 | 9.4% | 83% |
| Example 21 | LiCoO₂ | 8 | 196.2 | 182.2 | 92.9% | 0.131 | 11.5% | 80.2% |

From the electrochemical data of Examples 3 and 17 to 21 in Table 4, the batteries of Examples 3 and 17 to 21 all had high specific capacity, low resistance, and good high-temperature stability and cycle stability. Further, as can be seen from Table 4, the electrochemical performance of the cathode material can be further improved by adjusting the sintering time in the preparation process. This is because an appropriate amount of sintering time contributes to the crystal formation of the solid solution to form an effective coating layer, thus enhancing the coating effect.

### 5. Examples 22 to 26

A coating material was prepared in the same manner as in Example 3, but the coating amount of LaₓLi_{y}Co_{z}Oₐ was controlled at 0.05%, 0.1%, 0.3%, 0.4% and 0.5%, respectively.

Performance tests were performed respectively on Examples 3 and 22 to 26. The test results are shown in Table 5:

TABLE 5

| | | | | | | | | 800 cls, |
|---|---|---|---|---|---|---|---|---|
| | | | | | | | 60° C. | 25° C. |
| | | | | | | | Storage | Cycle |
| | | Coating | Charge | Discharge | | EIS | 21D | Capacity |
| | | Amount of | Specific | Specific | First | Rct | Expansion | Retention |
| | Substrate | LaₓLi_{y}Co_{z}Oₐ/% | Capacity | Capacity | Efficiency | (ohm) | Ratio | Rate |
| Example 22 | LiCoO₂ | 0.05 | 197.4 | 183.5 | 93.0% | 0.262 | 12.9% | 63.1% |
| Example 23 | LiCoO₂ | 0.1 | 196.8 | 183.1 | 93.0% | 0.175 | 11.6% | 75.4% |
| Example 3 | LiCoO₂ | 0.2 | 196.6 | 182.7 | 92.9% | 0.075 | 5.3% | 89.3% |
| Example 24 | LiCoO₂ | 0.3 | 194.3 | 180.5 | 92.9% | 0.072 | 5.1% | 86.8% |
| Example 25 | LiCoO₂ | 0.4 | 193.5 | 179.6 | 92.8% | 0.085 | 5.6% | 87.9% |
| Example 26 | LiCoO₂ | 0.5 | 193.0 | 178.6 | 92.5% | 0.097 | 5.8% | 79.1% |

From the electrochemical data of Examples 3 and 22 to 26 in Table 5, the batteries of Examples 3 and 22 to 26 all had high specific capacity, low resistance, and good high-temperature stability and cycle stability. Further, as can be seen from Table 5, the electrochemical performance of the cathode material can be further improved by adjusting the coating amount of LaₓLi_{y}Co_{z}Oₐ in the preparation process. This is because an appropriate coating amount of LaₓLi_{y}Co_{z}Oₐ can stabilize the surface structure of the substrate and facilitate the transport of lithium ions.

### 6. Examples 27 to 30

The battery prepared in Example 3 was respectively applied to operating voltages of 4.35 V, 4.4 V, 4.45 V, 4.48 V, 4.5 V and 4.55 V. The test results are shown in Table 6.

TABLE 6

| | | | | | | | | 800 cls, |
|---|---|---|---|---|---|---|---|---|
| | | | | | | | 60° C. | 25° C. |
| | | | | | | | Storage | Cycle |
| | | | Charge | Discharge | | EIS | 21D | Capacity |
| | | Operating | Specific | Specific | First | Rct | Expansion | Retention |
| | Substrate | Voltage | Capacity | Capacity | Efficiency | (ohm) | Ratio | Rate |
| Example 27 | LiCoO₂ | 4.35 V | 178.6 | 165.7 | 92.8% | 0.072 | 5.6% | 88.5% |
| Example 28 | LiCoO₂ | 4.4 V | 185.6 | 171.9 | 92.6% | 0.081 | 6.2% | 86.3% |
| Example 3 | LiCoO₂ | 4.45 V | 196.6 | 182.7 | 92.9% | 0.075 | 5.3% | 89.3% |
| Example 29 | LiCoO₂ | 4.48 V | 205.5 | 190.7 | 92.8% | 0.138 | 15.6% | 79.9% |
| Example 30 | LiCoO₂ | 4.5 V | 213.2 | 197.6 | 92.7% | 0.184 | 47.8% | 65.2% |

From the electrochemical data in Table 6, the lithium-ion battery prepared from the cathode material discussed in the present application can operate in a voltage range of about 4.3 to 4.55 V. Therefore, the cathode material prepared according to the embodiments of the present application can be used for a high-voltage lithium-ion battery, thereby achieving high energy density.

References throughout the specification to “some embodiments”, “partial embodiments,” “one embodiment,” “another example”, “examples”, “specific examples” or “partial examples” mean that at least one embodiment or example of the application includes specific features, structures, materials or characteristics described in the embodiments or examples. Therefore, descriptions appearing throughout the specification, such as “in some embodiments”, “in the embodiments”, “in an embodiment”, “in another example”, “in an example, “in a particular example” or “examples”, are not necessarily referring to the same embodiments or examples in the present application. Furthermore, the particular features, structures, materials or characteristics herein may be combined in any suitable manner in one or more embodiments or examples.

Although the illustrative embodiments have been shown and described, it should be understood by those skilled in the art that the above-described embodiments are not to be construed as limiting the present application, and variations, substitutions and modifications may be made to the embodiments without departing from the spirit, principle and scope of the present application.

1. A cathode material, comprising:
a substrate, wherein the substrate is a cathode active substance containing a cobalt element and capable of intercalating and deintercalating lithium ions; and
a coating layer, located on a surface of the substrate;
wherein the coating layer is LaₓLi_{y}Co_{z}Oₐ, wherein 1≤x≤2, 0<y≤1, 0<z≤1, 3≤a≤4 and 3x+y+3z=2a.

2. The cathode material according to claim 1, wherein in the cathode material, the mass fraction of LaₓLi_{y}Co_{z}Oₐ is from about 0.01% to about 5% or from about 0.2% to about 2%.

3. The cathode material according to claim 1, wherein LaₓLi_{y}Co_{z}Oₐ is 1.5≤x≤2, 0<y≤0.5, 0<z≤0.5 and 3.5≤a≤4.

4. The cathode material according to claim 1, wherein the general formula of the cathode active substance is expressed as Li_{c}Co_{d}M_{1'd}O₂, wherein M comprises at least one of Co, Ni, Mn, Al, Mg, Ti, Zr, F, Y, Nb, La, B, Mo, V or Ce, wherein 0.95≤c≤1.05 and 0.95≤d≤0.9999.

5. An electrochemical device, comprising a cathode, an anode, a separator and an electrolyte, wherein the cathode comprises a cathode material, and wherein the cathode material comprises:
a substrate, wherein the substrate is a cathode active substance containing a cobalt element and capable of intercalating and deintercalating lithium ions; and
a coating layer, located on a surface of the substrate;
wherein the coating layer is LaₓLi_{y}Co_{z}Oₐ, wherein 1≤x≤2, 0<y≤1, 0<z≤1, 3≤a≤4 and 3x+y+3z=2a.

6. The electrochemical device according to claim 5, wherein in the cathode material, the mass fraction of LaₓLi_{y}Co_{z}Oₐ is from about 0.01% to about 5% or from about 0.2% to about 2%. (Original) The electrochemical device according to claim 5, wherein LaₓLi_{y}Co_{z}Oₐ is 1.5≤x≤2, 0<y≤0.5, 0<z≤0.5 and 3.5≤a≤4.

8. The electrochemical device according to claim 5, wherein the general formula of the cathode active substance is expressed as Li_{c}Co_{d}M_{1-d}O₂, wherein M comprises at least one of Co, Ni, Mn, Al, Mg, Ti, Zr, F, Y, Nb, La, B, Mo, V or Ce, wherein 0.95≤c≤1.05 and 0.95≤d≤0.9999.

9. The electrochemical device according to claim 5, wherein the electrochemical device is a lithium-ion battery.

10. A method for preparing a cathode material that includes a substrate, wherein the substrate is a cathode active substance containing a cobalt element and capable of intercalating and deintercalating lithium ions; and a coating layer, located on a surface of the substrate; wherein the coating layer is LaₓLiₓCo_{z}Oₐ, wherein 1≤x≤2, 0<y≤1, 0<z≤1, 3≤a≤4 and 3x+y+3z=2a, the method comprising:
dispersing a lanthanum salt, a lithium salt and a cobalt salt in an organic solution, adding a complexing agent, stirring uniformly and removing the organic solution to obtain a LaₓLi_{y}Co_{z}Oₐ sol;
mixing the LaₓLi_{y}Co_{z}Oₐ sol with a cathode active substance containing a cobalt element and capable of intercalating and deintercalating lithium ions, and drying to obtain a gel precursor; and
mixing and sintering the gel precursor to obtain the cathode material.

11. The method according to claim 10, wherein in the cathode material, the mass fraction of LaₓLi_{y}Co_{z}Oₐ is from about 0.01% to about 5% or from about 0.2% to about 2%.

12. The method according to claim 10, wherein LaₓLi_{y}Co_{z}Oₐ is 1.5≤x≤2, 0<y≤0.5, 0<z≤0.5 and 3.5≤a≤4.

13. The method according to claim 10, wherein the general formula of the cathode active substance is expressed as Li_{c}Co_{d}M_{1-d}O₂, wherein M comprises at least one of Co, Ni, Mn, Al, Mg, Ti, Zr, F, Y, Nb, La, B, Mo, V or Ce, wherein 0.95≤c≤1.05 and 0.95≤d≤0.9999.
